(19) United States
(12) Patent Application Publication
(10) Pub. No.: US 2023/0263604 A1
(43) Pub. Date: Aug. 24, 2023

(54) SYSTEM AND METHOD FOR PRODUCING TEMPORARY DENTAL COVERINGS

(71) Applicant: Kenneth Wilstead, Garland, TX (US)

(72) Inventor: Kenneth Wilstead, Garland, TX (US)

(21) Appl. No.: 18/173,036

(22) Filed: Feb. 22, 2023

Related U.S. Application Data
(60) Provisional application No. 63/312,786, filed on Feb. 22, 2022.

(51) Int. Cl. A61C 13/107; A61C 9/00; A61C 5/30; A61C 19/04; A61C 13/30; A61C 13/34

(52) U.S. Cl. CPC A61C 13/0001; A61C 9/0006; A61C 5/30; A61C 19/04; A61C 13/30; A61C 13/34

(57) ABSTRACT

A set of baseline stents of people's teeth of different sizes may be used for a process to create temporary dental coverings. A range of sizes of the baseline stents may range from a smallest size to a largest size. A measurement of a stone-based model formed from a mold taken of the patient's natural teeth and gums may be made using a measurement tool. The measurement may include measuring from a left-side tooth to a corresponding right-side tooth. In an embodiment, unique identifiers (e.g., “A”-“N”) may be given to each of the baseline stents, and the measurement tool may show an identifier when the measurement is made. The baseline stent may be used to augment the model used to form a patient-specific stent used to take an impression of the patient's prepped teeth. The temporary dental coverings may be sculpted, shined, and attached to the prepped natural teeth.

### RELATED APPLICATIONS

This Application claims priority to U.S. Provisional Application having Ser. No. 63/312,786 filed on Feb. 22, 2022; the contents of which are hereby incorporated by reference in its entirety.

### BACKGROUND

Cosmetic dentistry is used for a variety of reasons, including making existing teeth look better, adding missing teeth, and brightening teeth, and so on. In general, cosmetic dentistry method focuses on improving the appearance of a patient's mouth, teeth, gums, and overall smile. Common procedures include teeth whitening, veneers, fillings, crowns, and implants.

When new smiles are created (by performing a cosmetic dentistry procedure), a dentist creates a model of the patient's teeth and sends the model to a laboratory to have permanent veneer and crowns (could be one or more tooth) created to be later implanted in the patient's mouth by the dentist. For the purpose of this description, the terms “veneer” and “crown” are referred to as a “dental covering,” and a dental covering can be either a veneer or crown. A crown is a tooth covering meant to adhere a tooth after about 20% of an outer layer of an entire tooth is removed from all directions, whereas a veneer is a tooth covering that is adhered to a tooth after about 20% of the front and sides of the tooth is removed. It typically takes one to two weeks for a lab to return a mold after enhancing the mold to a new and improved version to be used to make a temporary dental covering. Permanent dental coverings are generally made of Zirconia, porcelain, or metal and porcelain fused to metal and often take longer to produce, which is why temporary dental coverings are utilized. For temporary or permanent dental coverings that are to be mounted to existing teeth, the existing natural teeth are generally ground down 20% in all directions (e.g., generally circular stumps on which a temporary or permanent dental covering is mounted). In the event that the natural teeth to be covered are positioned in a viewable area of the patient's mouth, after the dentist (i) extracts the existing natural tooth and implants an anchor into the patient's mouth for a tooth to be mounted later on or (ii) grinds the natural tooth down to serve as a mounting post, the dentist typically has temporary dental coverings made so that the patient may have what appears to be proper teeth while the permanent dental coverings are being created by the laboratory. Natural teeth around the extracted tooth may act as an anchor (abutment) so that multiple crowns can be connected to function as a bridge, thereby enabling an artificial tooth to be supported over that space of the extracted tooth. Because, conventional procedures may take weeks for a laboratory to prepare the temporary dental coverings, if the removed natural teeth or ground down natural teeth are in a viewable area, the patient has to endure the embarrassment and inconvenience of his or her natural teeth looking poor. As such, there is a need for a dentist to be able to provide temporary dental coverings that are both aesthetically pleasing and functional for the patient in a shorter period of time, such as during a single extended office visit.

### BRIEF SUMMARY

To shorten the time it typically takes for a dentist to prepare temporary dental coverings for a patient having a cosmetic dentistry procedure, the principles described herein enable the dentist to rapidly prepare temporary dental coverings, generally within a few hours, for temporary installation(e.g., for a few weeks) in the patient's mouth while the dentist is waiting for a laboratory to create permanent dental coverings for the patient. The temporary dental coverings are generally made of acrylic, which is a material that is strong enough to be functional for the patient and may be made to look like natural teeth using certain manufacturing processes described herein.

So as to provide for the expedited process to prepare temporary dental coverings, certain processes and devices may be utilized. In one embodiment, a set of preformed stents over a range of different baseline sizes may be provided to a dentist and a measuring tool may be used to determine which of the baseline sizes to select in preparing the temporary dental coverings. For the purpose of this description, a baseline stent is a stent that has a size that corresponds to typical total spans extending between corresponding left and right side teeth (e.g., span distance extending from left and right canine teeth). In an embodiment, a kit that includes the preformed baseline stents over the range of baseline sizes and the measuring tool may be created for dentists to prepare the temporary dental coverings within an extended patient visit, thereby enabling the patient (i) to have his or her teeth prepared for permanent dental coverings to be placed and (ii) to have the temporary dental coverings positioned in the patient's mouth, thereby allowing the patient to leave the dental office with the temporary dental coverings that look like natural teeth as opposed to having very poorly prepared temporary dental coverings or prepared natural teeth that are either (i) ground down to serve as posts for the permanent dental coverings or (ii) missing due to being pulled and optionally with anchors that will ultimately serve as mounts for the permanent dental coverings. As a result, the patient is not stigmatized with the missing or ground down natural teeth while the temporary and/or permanent dental coverings to be created in a laboratory.

One embodiment of a method of forming a set of at least one temporary dental covering may include capturing an impression of existing natural teeth and gums of a patient to be used to form a mold of the patient's gums and natural teeth. A distance between (i) a first natural tooth on a left side of the patient's mouth and (ii) a second natural tooth on the right side of the patient's mouth may be measured. A selection, based on the measured distance, may be made of a baseline stent from amongst multiple sizes of baseline stents formed from a mold of natural teeth and gums of a different person. Hardening material to be hardened into the selected baseline stent may be disposed. The selected baseline stent with the hardening material may be placed onto the mold of the patient until the hardening material hardens, thereby forming an augmented mold of the patient's natural teeth and gums and inclusive of altered and/or additional molded teeth in the shape of the different person's natural teeth and gums. An augmented stent of the patient's existing natural teeth may be formed using the augmented mold. Hardening material may be disposed into the augmented stent. At least one natural tooth of the patient may be prepared by reducing size and shape thereof to form at least one anchor tooth to be used for the set of at least one temporary dental covering. An augmented impression mold may be formed by placing the augmented stent with the hardening material onto the patient's prepared teeth and gums to form an initial set of temporary teeth. The initial set of temporary teeth may be removed from the augmented mold. The initial set of temporary teeth may be sculpted to make the set of temporary teeth more realistic to form a sculpted set of temporary dental coverings. The sculpted temporary teeth may be secured to the prepared natural teeth and gums of the patient.

One embodiment of a dental kit may include multiple baseline stents having sizes ranging from a minimum size to a maximum size. The baseline stents may have respective shapes of teeth and gums of one or more persons for use in augmenting a stone-based model produced from natural teeth of a patient who is not any of the one or more persons.

One embodiment of a dental kit may include a measurement tool configured to measure a physical parameter between a tooth on a left side of a mouth and a tooth on a right side of a mouth, and multiple baseline stents sized within a lower and an upper range of the physical parameter. The baseline stents may have respective shapes of teeth and gums of one or more persons for use in augmenting a stone-based model produced from natural teeth of a patient who is not any of the one or more persons.

One embodiment of a measurement tool may include a housing, a flexible tape configured to measure a physical parameter spanning between a tooth on a left side of a mouth and a tooth on a right side of a mouth, and an indicator mechanism, driven by the flexible tape, to display an indicator of a size of a stent from a plurality of different sized baseline stents to be selected based on the indicator.

Another embodiment of a measurement tool may include a housing, a flexible tape configured to measure a physical parameter spanning between a tooth on a left side of a mouth and a tooth on a right side of a mouth, and an indicator mechanism, driven by the flexible tape, to display an indicator of a size of a stent from a plurality of different sized baseline stents to be selected based on the indicator.

One embodiment of a method of measuring a span across teeth may include displacing a flexible tape in response to the flexible tape of a measurement tool being pressed against a front surface of teeth of a patient. An indicator mechanism may be altered in response to the flexible table being displaced, thereby causing an indicator indicative of a distance of the span between a first tooth on a left side of the patient's mouth and a second tooth on a right side of the patient's mouth to be displayed. The indicator indicative of a size of a baseline stent from multiple different sized baseline stents to be selected based on the indicator may be displayed.

Another process of forming a set of at least one temporary dental covering may include selecting, based on the measured distance, a baseline stent from amongst a plurality of sizes of baseline stents formed from a mold of natural teeth and gums of a different person. Hardening material to be hardened may be disposed into the selected baseline stent. The selected baseline stent with the hardening material may be placed onto actual teeth of the patient until the hardening material hardens, thereby forming a direct augmented mold of the patient's natural teeth and gums and inclusive of molded teeth in the shape of the different person's natural teeth and gums. An augmented stent of the patient's existing natural teeth using the augmented mold may be formed. Hardening material may be disposed into the augmented stent. At least one natural tooth of the patient may be prepared by reducing size and shape thereof to form at least one anchor tooth to be used for the set of at least one temporary dental covering. An augmented impression mold may be formed by placing the augmented stent with the hardening material onto the patient's prepared teeth and gums to form an initial set of temporary teeth. The initial set of temporary teeth may be removed from the augmented mold. The initial set of temporary teeth may be sculpted to make the set of temporary teeth more realistic to form a sculpted set of temporary dental coverings. The sculpted temporary teeth may be secured to the prepared natural teeth and gums of the patient.

### BRIEF DESCRIPTION OF THE DRAWINGS

For a detailed description of various examples, reference will now be made to the accompanying drawings in which:

FIG. 1 is an image of an illustrative alginate impression of a patient's natural teeth and gums;

FIGS. 2A and 2B are images of an illustrative stone-based model formed by the alginate impression of the patient's natural teeth and gums;

FIGS. 3A and 3B are images of an illustrative sub-process for altering (e.g., smoothening) the model of the patient's natural teeth and gums of FIGS. 2A and 2B;

FIG. 4 is an image of an illustrative process for measuring a distance between a left-side tooth and right-side tooth for determining a baseline stent from amongst multiple sizes of baseline stents formed from molds or models of natural teeth and gums of different persons than the patient;

FIG. 5 is an image of an illustrative set of bins containing multiple sizes of the set of baseline stents ranging from a small size to a large size of baseline stents;

FIG. 6 is an image of an illustrative three-dimensional (3D) print of a model of a person's teeth and gums used to produce a baseline stent of a particular size;

FIGS. 7A-7C are images of an illustrative sub-process for using a baseline stent selected based on the measured distance of the patient's teeth of FIG. 5 being applied with flowable material placed therein to the stone-based model formed from the patient's teeth and gums to form a profile of the baseline stent on the model, thereby forming an augmented model;

FIGS. 8A-8C are images of an illustrative sub-process for creating and adding a new tooth to the augmented model of the patent where a tooth previously did not exist;

FIG. 8D is an image of an illustrative baseline stent including demarcations or perforations to enable a dental professional or manufacturer to more easily form a portion of a stent, such as a portion that includes one or more teeth for use in creating a manufactured model tooth;

FIG. 9 is an image of an illustrative process for grinding the model on an opposite side of the teeth to reduce thickness of the model to cause an opening to form on the roof of the mouth of the model, thereby enabling a patient-specific stent that matches the patient's teeth and gums as defined by the augmented model to be formed;

FIGS. 10A and 10B are images of an illustrative suck-down machine that is forming a patient-specific stent using a soft plastic material to match the patient's teeth and gums using the augmented model of FIG. 9;

FIG. 11A-11C are images of an illustrative sub-process of the soft-plastic material that formed around the augmented model in the suck-down machine of FIGS. 10A and 10B to become a patient-specific stent may be cut from the tray on which the augmented model is placed for use in the suck-down machine;

FIG. 12A-12C are a series of images of an illustrative sub-process for adding missing teeth to the stone-based model;

FIGS. 13A-13F are images of an illustrative sub-process for processing an impression formed using the augmented model and patient-specific stent with hardening material as applied to the natural teeth and gums of the patient;

FIGS. 14A and 14B are illustrations of an illustrative measurement tool for use in measuring a distance of a total span between a tooth on a left side of a patient's mouth and a corresponding tooth on a right side of the patient's mouth;

FIG. 14C is an illustration of an alternative embodiment of the measurement tool that utilizes digital measuring features;

FIGS. 15A and 15B are illustrations of the measurement tool of FIG. 14A being used to measure the stone-based model made by taking an impression of natural teeth of a patient; and

FIGS. 16A and 16B are images of respective natural teeth of a patient and temporary dental coverings applied to prepped teeth of the patient within a single treatment session.

### DETAILED DESCRIPTION

To expedite the creation and installation of temporary dental coverings between a time that a patient's natural teeth are prepared or prepped for permanent dental coverings, a set of baseline stents (sometimes called a bleaching tray) having a size range from a low end to a high end that generally fit a full size range of patients' teeth by having sizes of the baseline stents with small enough differences (e.g., 0.5 mm between successive baseline stents) may be utilized to assist with creation of the dental coverings. The baseline stents may be considered baseline stents that have sizes defined by a producer of the baseline stents to be standard sizes. For a dental professional to determine which of the baseline stents to select, a measurement using a measurement tool, for example, may be made to determine total distance over a total span of teeth, such as one tooth on a left side and one on the right side (e.g., canine teeth), across the front of the teeth, for example, may be made. Once selected, the dental professional may use the baseline stent to form or to help form an improved model of the patient's teeth. The model or improved model may thereafter be used to create a new patient-specific stent that may be used to form temporary dental coverings that may thereafter be positioned in the patient's mouth until permanent dental coverings can be produced. Using the devices and processes described herein may enable the dental professional to create dental coverings within a few hours of the same day of a first visit, thereby enabling a patient to go home from the dental procedure with a cosmetically enhanced correct set of temporary dental coverings as opposed to making another appointment in a week or two. By preparing the temporary dental coverings during a patient's first dental visit for cosmetic dentistry to improve a patient's smile, the patient is able to leave the dental visit with the temporary dental coverings that fit and look aesthetically pleasing and avoid a second visit or ugly (i.e., non-aesthetically pleasing) dental coverings that often do not fit and currently occur on the same day. That is, using the principles described herein, aesthetically pleasing and properly fit temporary teeth (in the form of temporary dental coverings) may be created and installed during a first visit of the cosmetic dental process.

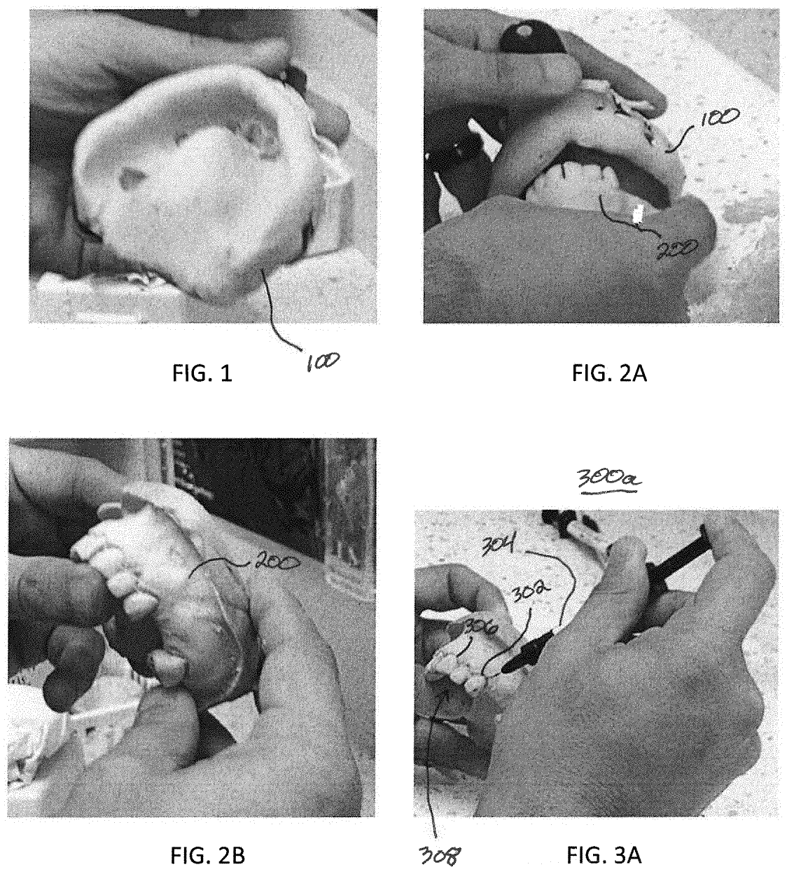

With regard to FIG. 1, an image of an illustrative alginate impression 100 of a patient's natural teeth and gums is shown. As understood in the art, the alginate impression is formed by taking an impression of the patient's natural teeth and gums. The impression 100 is of a top set of natural teeth and gums, but it should be understood that the impression 100 could additionally and/or alternatively be of the patient's bottom natural teeth and gums.

With regard to FIGS. 2A and 2B, images of an illustrative stone-based model 200 formed by the alginate impression 100 of FIG. 1 of the patient's natural teeth and gums are shown. The model 200 may be composed of a mixture of stone and water that, when in a soft state and placed into the alginate impression 100, may harden, thereby resulting in an inverse profile of the alginate impression 100 so as to become the hardened stone-based model 200. The model 200 may be augmented or modified in a manner that makes an improved set of temporary dental coverings, as further described hereinbelow. For example, as shown in the model 200, the patient on which the impression 100 was captured has crooked and spaced front teeth and a tooth is missing from the front six teeth. The model 200 may be augmented to straighten the teeth of the model and add a tooth to the model 200 such that a set of temporary dental coverings will be both straight and complete (i.e., no missing tooth).

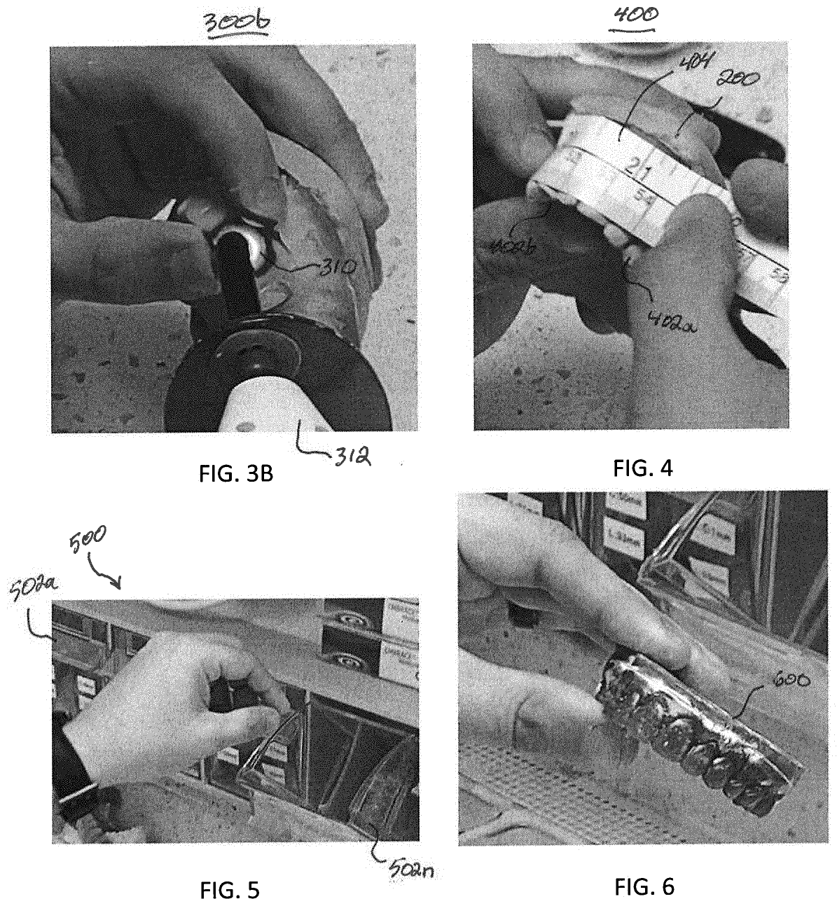

With regard to FIG. 3A, an image of an illustrative process 300a for augmenting or altering (e.g., smoothening) the model 200 of FIGS. 2A and 2B of the patient's natural teeth and gums is shown. Flowable material 302, which is a hardening material that may be cured using ultraviolet light, such as an illumination light 310 (e.g., ultraviolet light (UV) of FIG. 3B), may be dispensed from a dispenser 304 into regions of the model 200 that have undesirable spacing or shape. Often the undesirable spacing or shape are at the gingival margin 306 (i.e., between the teeth and gums), but may also be anywhere along model teeth 308 of the model 200, including along the front or rear face of the model teeth 308 or along edges of the teeth (e.g., between teeth). In addition, the flowable material 302 may be placed into blemishes formed in the model 200 due to normal malformations while creating the impression 100 of FIG. 1 and/or model 200. The flowable material 302 may be used to smoothen certain regions that might otherwise cause temporary dental coverings formed using the model 200 to be uncomfortable to the patient.

With regard to FIG. 3B, an image of an illustrative process 300b for hardening the flowable material 302 using an illumination source (e.g., UV light source) 312 that produces illumination 310 (e.g., UV light) that causes the flowable material 302 to cure and harden on the model as shown in FIG. 3A is shown. It should be understood that a wide variety of flowable materials that may be cured using an illumination source or otherwise (e.g., heat) to expedite the curing process may be utilized.

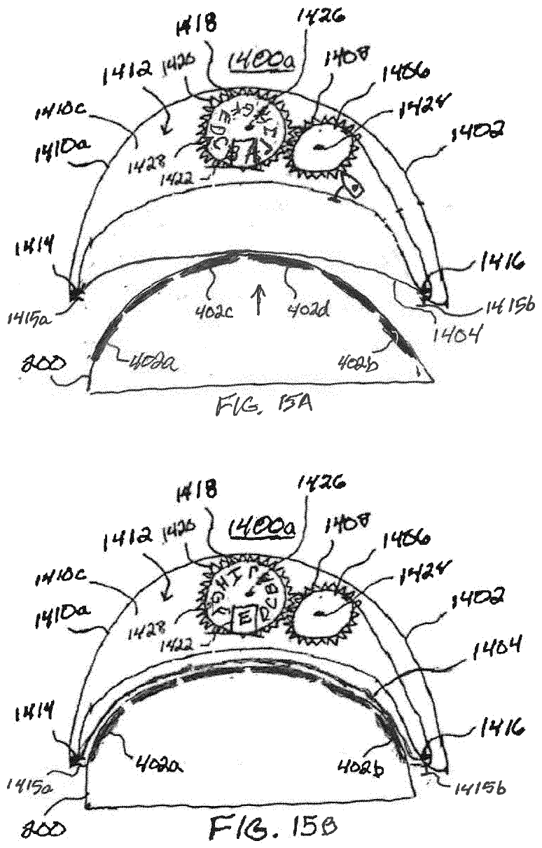

With regard to FIG. 4, an image of an illustrative process 400 using the model 200 of FIG. 2, pre- or post-augmentation from the process 300 of FIGS. 3A and 3B, for measuring a distance between a left-side tooth 402a and right-side tooth 402b (e.g., left and right canine teeth) for determining a baseline stent from amongst a range of sizes of baseline stents (see FIG. 5, for example) formed from molds or models of natural teeth and gums of different persons than the patient is shown. In an embodiment, a flexible measuring tape 404 may be utilized to measure the distance between the teeth 402a and 402b. Alternatively, to simplify the measurement and selection of a baseline stent processes, a measurement tool (see FIG. 14A and 14B, for example) that may produce a measurement value or an identifier of a baseline stent size may be utilized. The identifier of a baseline stent size may be letters (e.g., size A-N), color (e.g., colors of a rainbow associated with the different baseline stent sizes), or otherwise. The number of baseline stents in the range of baseline stents may include 20 baseline sizes, for example. However, any number of sizes of baseline stents may be provided and organized into bins or other containment systems, as shown in FIG. 5.

With regard to FIG. 5, an image of an illustrative set of bins containing multiple sizes of the set of baseline stents ranging from a small size to a large size of baseline stents is shown. The baseline stents may be stored in a storage system 500 and arranged in ascending order of bins 502a-502n (collectively 502) from left to right of smallest to largest baseline stents. In an embodiment, the different sized baseline stents may be assigned different identifiers, such as numbers (e.g., 1-20), letters (e.g., A-T), or combination thereof, that are indicative of sizing, and the bins 502 may be labeled with such identifiers in ascending size and in alphabetical order, for example. In another embodiment, the baseline stents may be colored (e.g., colors of a rainbow) and arranged from darkest color to brightest color or vice versa. The sizes of the baseline stents may be separated by a certain number of measurement units, such as millimeters. For example, the baseline stents may each be separated by 0.5 mm in size. In an alternative embodiment, the sizes at the lower and upper sizes of the baseline stents may be separated by 1 mm while the sizes in the middle that are more typical of individuals may be spaced by 0.5 mm in size. In an embodiment, the smallest five sizes may be spaced by 1 mm, the largest five sizes may be spaced by 1 mm, and the middle ten sizes may be separated by 0.5 mm.

If baseline stents are available for both kids and adults, then multiple sets of bins (additional sets of bins not shown, but may be the same or similar to the bins 502) and baseline stents may be available. The number of baseline stents for kids and adults may be the same or different. However, baseline stents for kids may have different size spacing (e.g., 0.25 mm) between each of the baseline sizes as a difference in size from the smallest to largest sizes may be less than for adults. Alternative subsets of baseline stents that utilize the same or different sizing parameters may be used based on different categories of demographics, for example. For example, although it has been found that male and female sizing is generally the same, it may be possible or desirable to created different baseline stents for male and female patients. Other physical considerations may be utilized in creating sets of baseline stents. However, it is generally understood that a primary defining physical feature is a total span distance between a corresponding pair of left and right teeth (e.g., left and right canines). Gender typically does not change teeth shape or spacing, but it is contemplated that gender may also be used to define a set of baseline stents. Moreover, as further described herein, it may be possible to capture an impression of an individual (e.g., celebrity) and create a set of baseline stents that are physically scaled upwards and/or downwards so that those stents may be applied to virtually any patient with dimensions over a wide range. More specifically, to obtain a stent in the shape of a celebrity, an impression is to be taken from the celebrity to produce a stone-based model so that a stent may be produced therefrom. A process may be used to digitize the impression and then a full range of sizes may be created by digitally scaling. 3D printed models (see FIG. 6) may be made so that baseline stents may be produced from the 3D models or, alternatively, 3D printing or plastic injection molding may be directly performed to produce those baseline stents of the celebrities, as was done for the non-celebrity stents.

With regard to FIG. 6, an image of an illustrative three-dimensional (3D) printed mold 600 of a model of a person's teeth and gums used to produce a baseline stent of a particular size is shown. The 3D printed mold 600 may be produced from a person's natural teeth or permanent dental coverings. The 3D printed mold 600 is one way to form a mold for use in creating multiple baseline stents for that particular size of a baseline stent. It should be understood that alternative molds using any number of materials for the mold may be possible. For example, the mold may be plastic, stone, metal, glass, natural material, synthetic material, and/or any other material formed of any process. The mold 600 may be formed of a person who has teeth and gums that may be considered aesthetically pleasing (e.g., nicely shaped) and that may be easy to replicate and manipulate when forming temporary dental coverings (e.g., teeth with sufficient spacing from one another with proper gingival margin).

Because the 3D printed mold 600 is digitized, the impression of another person, such as a celebrity, may be digitally altered based on spacing used to produce the various sizes of the baseline stents. For example, if the other person has natural, dental coverings, or combination thereof, of a certain distance between a first and second tooth on a left and right side of his or her mouth, as previously described, then the digital representation of the teeth may be scaled, translated, rotated, or otherwise

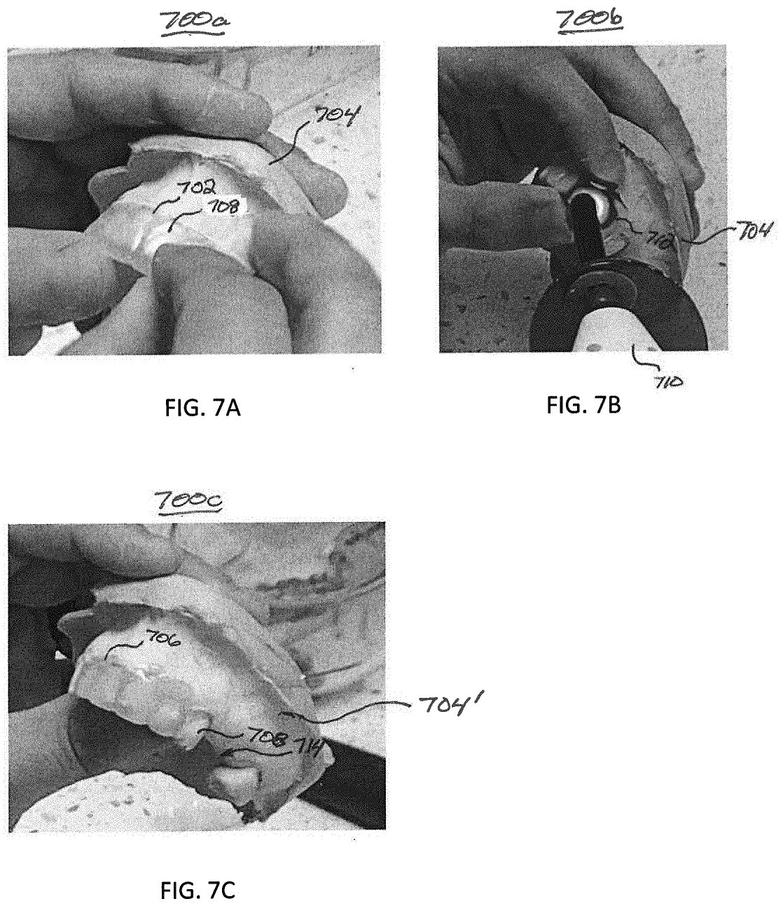

With regard to FIGS. 7A-7C, images of an illustrative sub-process 700a-700c (collectively 700) for using a baseline stent 702 selected based on the measured distance of the patient's natural teeth of FIG. 4 being applied with flowable material (see FIG. 3A) placed therein to the stone-based model 704 formed from the patient's natural teeth and gums, thereby forming a profile of the baseline stent 702 on the model 704. The measurement of the patient's natural teeth may be performed directly on the patient's actual teeth or from the stone-based model 704. Resulting from applying the flowable material 706 to the stone-based model 704 formed from the patient's natural teeth and gums is an augmented model 704′ that now has teeth in the shape of the baseline stent 702. In other words, the teeth 708 that are shaped onto the stone-based model 704 are generally going to be nicer than the natural teeth of the patient since the baseline stent 702 was selected from a person with aesthetically pleasing teeth and gums.

With regard to FIG. 7A, an image of an illustrative baseline stent 702 selected based on the measured distance of the patient's natural teeth of FIG. 4 being applied with flowable material 706 placed therein to the stone-based model 704 formed from the patient's natural teeth and gums is shown. The flowable material 706 may be any material that is capable of being poured or injected into a space defined by the baseline stent 702, where the space represents teeth and gums of another person (i.e., not the current patient). The flowable material 706 shall also be capable of adhering to the stone-based model 704 and be capable of being hardened by an external light source 710, such as UV light 712, that causes the flowable material 706 to harden. It should be understood that the flowable material 706 may be capable of curing using other techniques, such as being mixed with a curing agent or hardening over a relatively short period of time (e.g., within 5 minutes).

With regard to FIG. 7B, an image of an illustrative process for curing the flowable material 706 to the model 704 after the flowable material 706 in the baseline stent 702 has been applied to the teeth 708 of the model 704 using the baseline stent 702 is shown. A light 712, such as a UV light, which is typically blue in color, may be illuminated onto the flowable material 706 that is being held to the stone-based model 704 by a dental professional pressing the baseline stent 702 with the flowable material 706 to the stone-based model 704. The dental professional may then illuminate the baseline stent 702, which is generally transparent (or substantially transparent to the wavelength of the light 712) to cause the flowable material 706 to cure and harden to the stone-based model 704, thereby augmenting the stone-based model 704 with the teeth and gum profile of another person and defined by the baseline stent 702 to form the augmented stone-based model 704′.

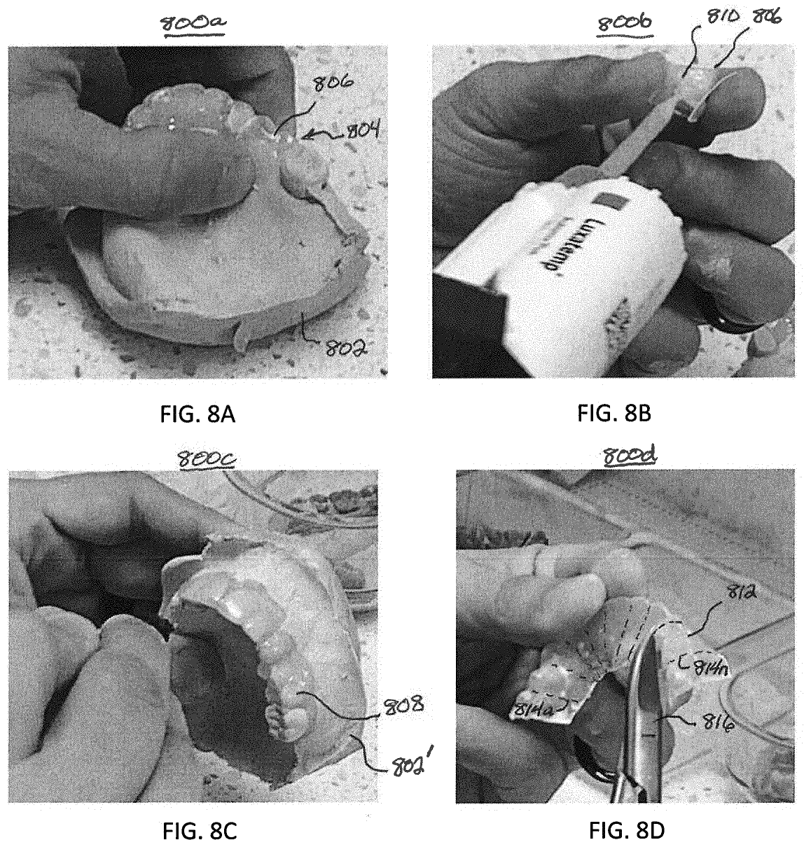

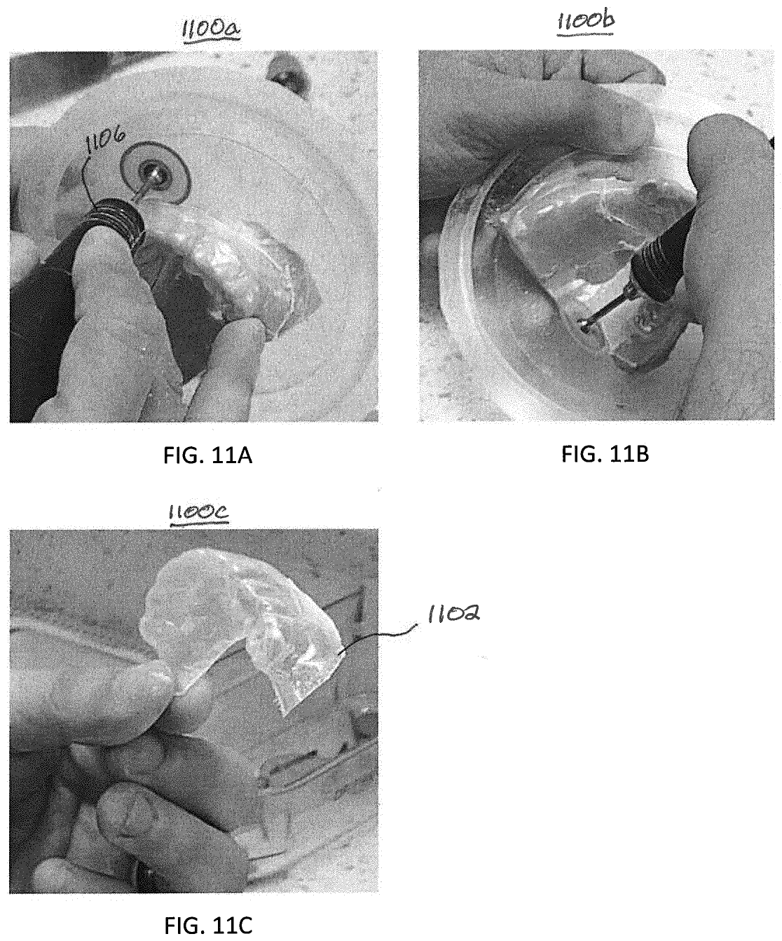

With regard to FIG. 7C, an image of the augmented model 704′ having cured flowable material 706 on the stone-based model 704 of the patient's natural teeth, where the flowable material 706 is now in the shape or profile of the another person's teeth and gums that were used to form the baseline stent 702 is shown. The hardened flowable material that is attached to the stone-based model 704 now defines aesthetically pleasing teeth and gums that can be used to form a patient-specific stent (see FIG. 11C, for example). Before creating the patient-specific stent, however, the dental professional may further process the augmented stone-based model 704′. For example, the dental professional may grind down or trim the augmented stone-based model 704′ to remove or reduce artifacts or other formations that may be uncomfortable for the patient or aesthetically unpleasing. Additionally, and as shown, a space 714 exists in the augmented stone-based model 704′ where the patent is missing a natural tooth. Prior to forming the patient-specific stent, it may be possible and desirable for the patent to have a manufactured tooth positioned in that space on the augmented stone-based model 704′ so that the patient-specific stent to be formed will have a profile that allows for a temporary dental covering to be positioned in the patient's mouth, as further shown in FIGS. 8A-8C. It should be understood that a manufactured model tooth may be added to the model 704, as well. The manufactured model tooth is also described hereinbelow with regard to FIGS. 8A-8C.

With regard to FIGS. 8A-8C, images of steps 800a-800c (collectively 800) an illustrative sub-process for creating and adding a manufactured model tooth 808 (FIG. 8C) to the model 802 of the patent to a space 804 where a tooth mold previously did not exist are shown. As shown in FIG. 8A, a portion 806 of a baseline stent that defines a tooth to be formed on the model 802. The portion 806 may match the size as the baseline stent determined from the measurement of the patient (e.g., either measuring the model produced from a model produced by the patient's teeth and gums or measuring the teeth of the patient directly, as previously described). In an embodiment, the portion 806 of the baseline stent may be cut from a baseline stent by the dental professional handling the augmentation of the stone-based model 802. Alternatively, the portion 806 of the baseline stent of a particular tooth may be produced separately either by forming an individual tooth or cut from a baseline stent and provided to dental professionals as supplements or accessories with the set of baseline stents. For example, if the baseline stents are meant to form the front six teeth of a patient, then portions of the baseline stents corresponding to each of the six teeth may be provided and included in the same or separate bins in which the corresponding sized baseline stents are stored. For example, the same size or smaller bins that extend above or below the bins 502 (FIG. 5) of the baseline stents may be used to store the six different portions of the baseline stents), thereby minimizing work (e.g., having to cut a baseline stent) for the dental professional while augmenting the stone-based model 802.

As further shown in FIG. 8A, the portion 806 of the baseline stent may be positioned on the stone-based model 802 to ensure that the portion fits within the space 804 at which the manufactured model tooth 808 (FIG. 8C) is to be added to the stone-based model 802. The portion 806 of the baseline stent that defines a tooth (or teeth) may be filled with a hardening material 810 (FIG. 8B), such as acrylic or any other hardening material, that may take the shape of the portion 806 of the baseline stent. While flowable material could be used to fill the baseline stent, because of the volume needed to form a manufactured model tooth, acrylic or other hardening material is typically more appropriate.

As shown in FIG. 8B, a hardening material 810 is shown to be injected into the portion 806 of the baseline stent of FIG. 8A that was fitted into the space 804 of the missing tooth of the model 802. The hardening material 810 may be filled to ensure there is sufficient material to fill the tooth profile of the portion 806 of the baseline stent and attach to the stone-based model 802.

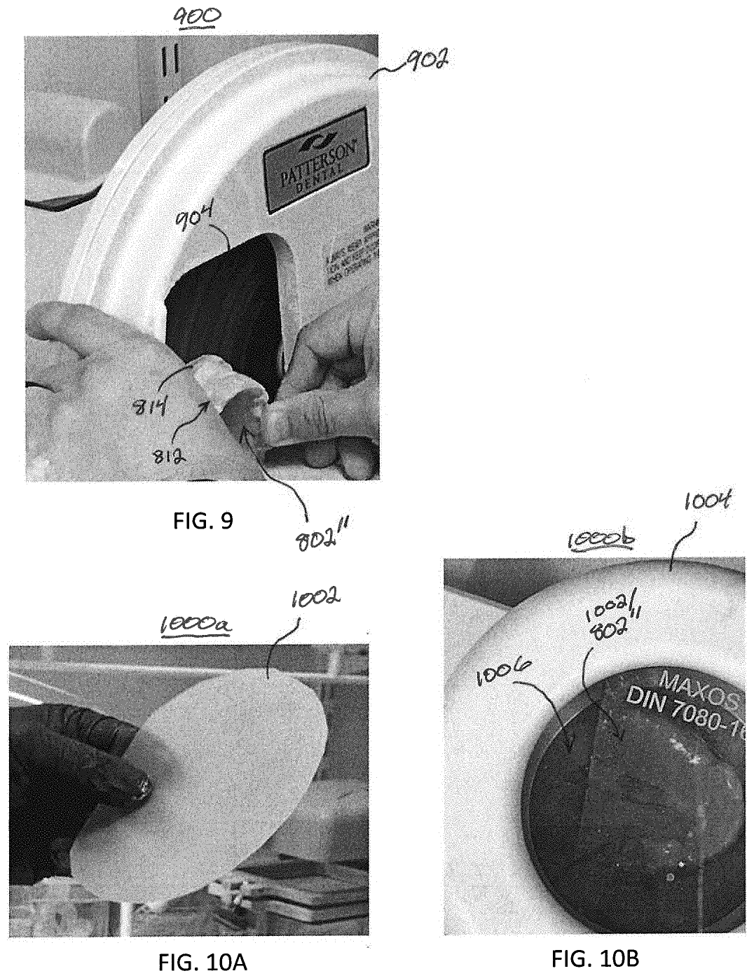

As shown in FIG. 8C, after the portion 806 of the baseline stent with the hardening material 810 is pressed onto the stone-based model 802, the hardening material 810 once hardened and attached to the stone-based model 802 in the open space 804 of the missing tooth may form the manufactured model tooth 808. For both cosmetic and comfort purposes, flowable material may be applied to the gingival margins to smoothen out and fill any gaps resulting from the added tooth using the same or similar processes described hereinabove. After the various augmentations (e.g., applying flowable material to fill in gaps, add material via the baseline stent, adding missing teeth, if any teeth are missing) are made to the stone-based model 802, additional alterations to prepare an augmented stone-based model 802′ for creation of a patient-specific stent may be performed, as described with regard to FIGS. 9 and 10. It should be understood that although it is possible to remove the stone-based teeth from the model 802 and replace some or all with the teeth from the baseline stent, any natural teeth that exist from capturing an impression of the patient's natural teeth and gums and imprinted onto the stone-based model 802 may be used for alignment purposes of a patient-specific stent using an augmented model 802′ produced from the stone-based model 802, as further described hereinbelow.

With regard to FIG. 8D, an image of an illustrative baseline stent 812 including demarcations or perforations 814a-814n (collectively 814) to enable a dental professional or manufacturer to more easily form a portion of a stent, such as a portion that includes one or more teeth for use in creating a manufactured model tooth is shown. The demarcations or perforations 814 may extend between individual tooth portions, and make it easier to cut using a cutting tool 816 to produce a tooth stent from the baseline stent 812 that matches size and configuration of the remainder of the baseline stent 812 to assist the dental professional in producing a manufactured model tooth, such as the manufactured model tooth 808 of FIG. 8A.

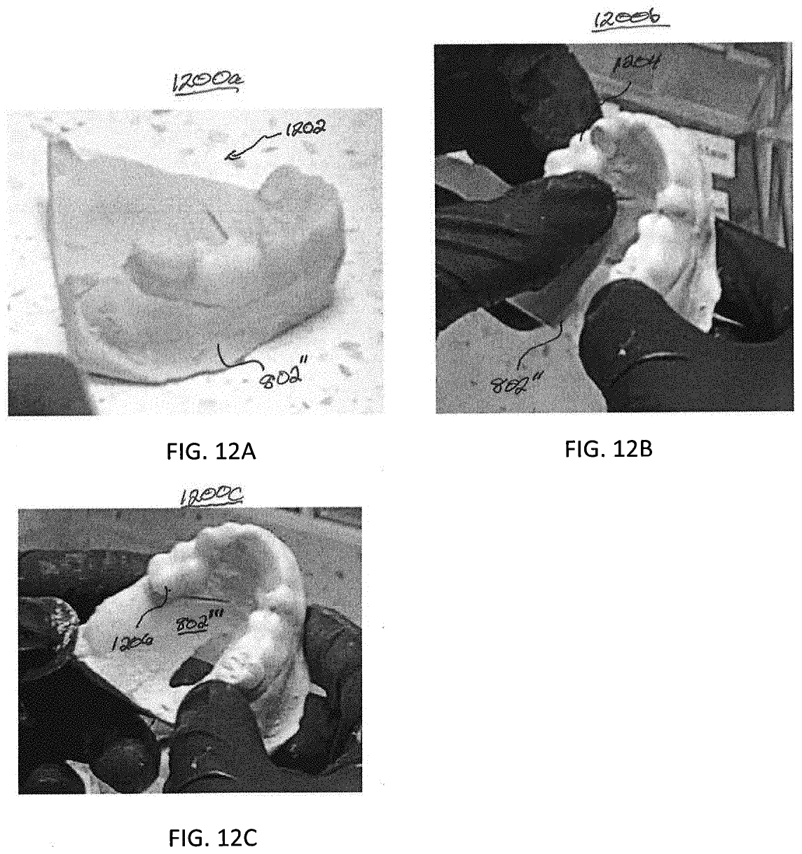

With regard to FIG. 9, an image of an illustrative process 900 for using a standard grinding machine 902 for grinding the augmented stone-based model 802′ on an opposite side of the teeth 812 to reduce thickness of a base portion 814, which corresponds to roof of a mouth for upper teeth, to the point that an opening (see FIG. 12C) is formed on the base portion 814 of the augmented stone-based model 802′ to form a thinned augmented stone-based model 802″ to enable a patient-specific stent that matches the patient's teeth and gums as defined by the augmented model 802′ to be formed is shown. The dental professional may press the non-teeth side of the augmented model 802′ against a spinning grinding element 904 to grind down the augmented model 802′ to thin the augmented model 802′ to eventually form the opening on the base portion 814. If an augmented model 802′ were for lower teeth of the patient's jaw, the opening would be formed on a bottom, chin side of the jaw. A patient-specific stent may thereafter be formed from the thinned augmented model 802″ by using soft plastic normally used to form stents. As previously described, the stent may be clear plastic. Alternative color plastic may be utilized. The soft plastic (or any other material) may be softened by being heated so that the plastic may be deformed to take a profile shape of the thinned augmented model 802″ when vacuum-sucked (see, for example FIG. 10) to the thinned augmented model 802″. The augmented model 802′, as previously described, is a combination of the patient's teeth and gums augmented by flowable material applied to the model using a properly sized baseline stent along with any other alterations made by the dental professional using flowable material, filing, and/or adding manufactured model teeth by using portion(s) of a baseline stent matching the properly sized baseline stent of one or more corresponding teeth.

With regard to FIGS. 10A and 10B, steps 1000a and 1000b (collectively 1000) an illustrative sub-process for forming a patient-specific stent (see FIG. 11C) is shown. With regard to FIG. 10A, an illustrative soft-plastic material 1002 that is used to form a stent is shown. The soft-plastic material 1002 is circular in shape, but may be any other shaped soft-plastic material may be utilized. The soft-plastic material may vary in flexibility, thickness, chemical composition, etc. In an embodiment, the soft-plastic material 1002 used to form the baseline stents may be softer or more flexible than soft-plastic material that is used to form the patient-specific stents because the baseline stents are used in augmenting the stone-based models so added flexibility is helpful during that sub-process, while the soft-plastic material 1002 used to form the patient-specific stents provides more rigidity and stability when making an impression with the hardening material of the patient's actual teeth and gums.

With regard to FIG. 10B, a top view image of an illustrative suck-down machine 1004 for forming a patient-specific stent using the soft plastic material 1002 to match the patient's teeth and gums using the thinned augmented model 802″ is shown. The suck-down machine 1004 includes a vacuum chamber 1006 into which the thinned augmented model 802″ may be placed in the vacuum chamber 1006 with the soft-plastic material 1002 being placed on top of the teeth 812 of the thinned augmented model 802″. More specifically, the thinned augmented model 802″ is placed on a tray or removable surface on which the thinned augmented model 802″ is placed with the soft-plastic material 1002 placed on top of the thinned augmented model 802″. When the suck-down machine 1004 is turned ON and the vacuum level increases (i.e., a negative pressure occurs in the vacuum chamber 1006), the soft-plastic material envelopes 1002 around the teeth-side of the thinned augmented model 802″, thereby causing the soft-plastic material 1002 to take an inverted shape of the teeth and gums of the thinned augmented model 802″.

With regard to FIG. 11A-11C, images of steps 1100a-1100c of an illustrative sub-process for modifying the soft-plastic material 1002 (FIG. 10A) that formed around the thinned augmented model 802″ in the suck-down machine 1004 of FIG. 10 to become a patient-specific stent 1102 may be cut from a tray 1104 on which the thinned augmented model 802″ is placed for use in the suck-down machine 1004 is shown. Because the soft-plastic material 1002 is deformable, applying the vacuum within the vacuum chamber 1006 causes the soft-plastic material 1002 to deform onto the thinned augmented model 802″. As the soft-plastic material 1002 cools, the soft-plastic material 1002 hardens in the inverse shape or profile of the thinned augmented model 802″ including any augmentations made to the original stone-based model 802 made from the alginate impression formed from the patient's natural teeth and gums. After completing the formation of the patient-specific stent 1102 formed from the soft-plastic material 1002, which may take two minutes or less, the dental professional may cut the shaped patient-specific stent 1102 from (i) the tray 1004 as shown in FIG. 11A using a rotary drill 1106, which is a common dental tool, and (ii) the thinned augmented model 802″ as shown in FIG. 11B. Other tools to separate the patient-specific stent 1102 from the tray 1104 and thinned augmented model 802″ may be utilized. Excess material may be trimmed from the patient-specific stent 1102 using the rotary drill 1106 or another cutting tool. For example, if only the front six teeth of the stent 1102 are to be kept, then any teeth that are formed into the patient-specific stent 1102 that are not the front six teeth may be trimmed or cut off. Also, excess material that extends behind the teeth region towards the roof of the mouth (or tongue) may be trimmed. The patient-specific stent 1102 is shown in FIG. 11C. A trimmed patient-specific stent that is limited to the front six teeth, for example, is not shown, but understood to be a reduced version of the stent 1102.

The patient-specific stent 1102 or trimmed patient-specific stent is thereafter used to form a set of temporary dental coverings on the patient's actual prepped natural teeth (i.e., natural teeth that are ground down to stubs on which the temporary and ultimately permanent dental coverings are to be attached) by applying hardening material (e.g., acrylic or other hardening material) into the patient-specific stent 1102 and then pressing the patient-specific stent 1102 onto the prepped natural teeth to harden the hardening material. The hardening of the hardening material typically takes around five minutes. The hardened material in the patient-specific stent 1102 defines an impression of the prepped natural teeth with a profile of the thinned augmented model 802″ such that a resulting set of temporary dental coverings that match the patient's mouth and have aesthetically correct appearance. In one embodiment, if the thinned augmented model 802″ was augmented using a baseline stent of a celebrity, then the hardening material in the patent-specific stent 1102 is a patient-specific model that includes impressions of the prepped natural teeth of the patient on a side opposite the teeth and the teeth are shaped as the celebrity's teeth.

With regard to FIG. 12A-12C, steps 1200a-1200c (collectively 1200) of an illustrative sub-process for adding missing teeth to the thinned stone-based model 802″ is shown. The steps 1200 of the sub-process are similar to the steps 800 of the sub-process of FIGS. 8A-8C, where a single manufactured model tooth 808 was added to the model 802. In this case, a portion of a baseline stent that includes the teeth, such as two teeth, that align with the missing teeth to be added to the model. To create the portion of the teeth to be added, a scissor or other tool may be utilized. In an embodiment, the baseline stents may have perforations defining regions of one or more successive teeth. In the event that a dental professional needs to create portion of the baseline stent for one or more particular teeth, the dental professional may simply cut or tear along the perforation(s) of the baseline stent that define the portion with the desire teeth. In an alternative embodiment, rather than having perforations, demarcations (e.g., lines, indents, ridges, markings, or any other demarcation) may be placed on the baseline stent to aid a dental professional in cutting or separating the baseline stent in the desired region including the desired teeth.

In particular, FIG. 12A are images that show that the thinned stone-based model 802″ includes a region 1202 in which teeth are missing on one side of the stone-based model 802 as a result of the patient not having natural teeth on the upper side of the his or her mouth. As previously described with regard to the sub-process of FIGS. 8A-8C, a portion 1204 of a baseline stent that include teeth of another person that align or correspond with the missing teeth of the current patient may be filled with hardening material (see FIG. 8B) and applied to the model 802″ in FIG. 12B. The portion 1204 of the baseline stent with the hardening material may be held together with the model, as shown in FIG. 12B, for a few minutes to allow the hardening material to harden onto the thinned augmented model 802″. As shown in FIG. 12C, additional manufactured model teeth 1206 are now included on an upgraded thinned augmented model 802″. Thereafter, the same sub-processes of FIGS. 10A-10B and 11A-11C may be performed to form a new patient-specific stent with the additional teeth formed on the upgraded thinned augmented model 802″'. Although the additional teeth 1206 are added to the thinned augmented model 802″, it should be understood that the additional teeth 1206 may have been added to prior models, such as the stone-based model 802, augmented stone-based model 802′, or thinned augmented stone-based model 802″, which would have eliminated having to make a second patient-specific stent in this case.

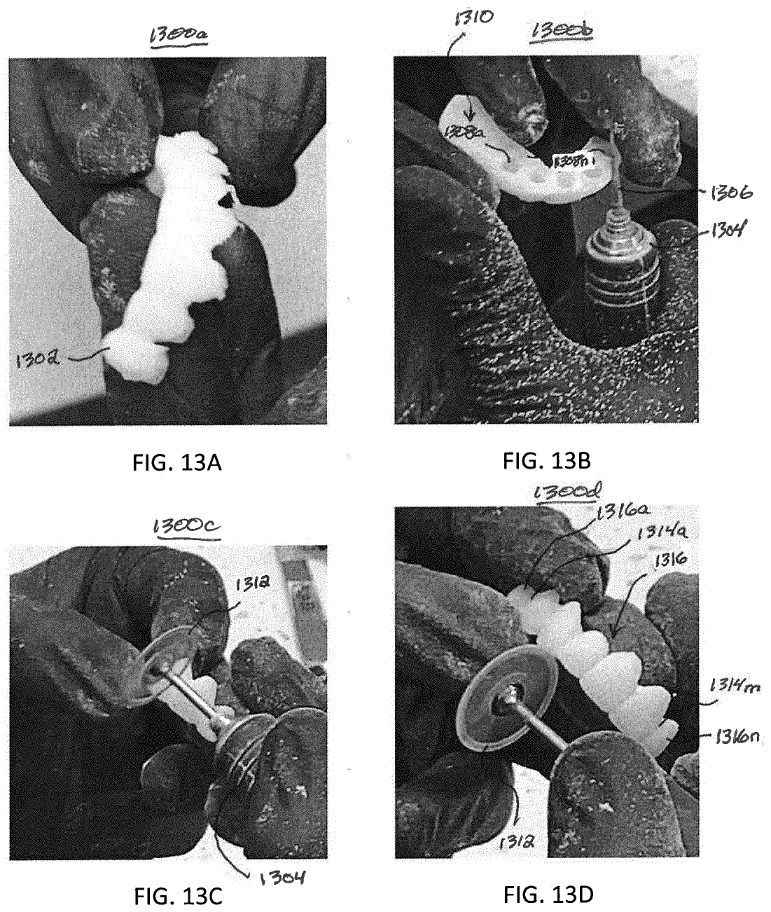

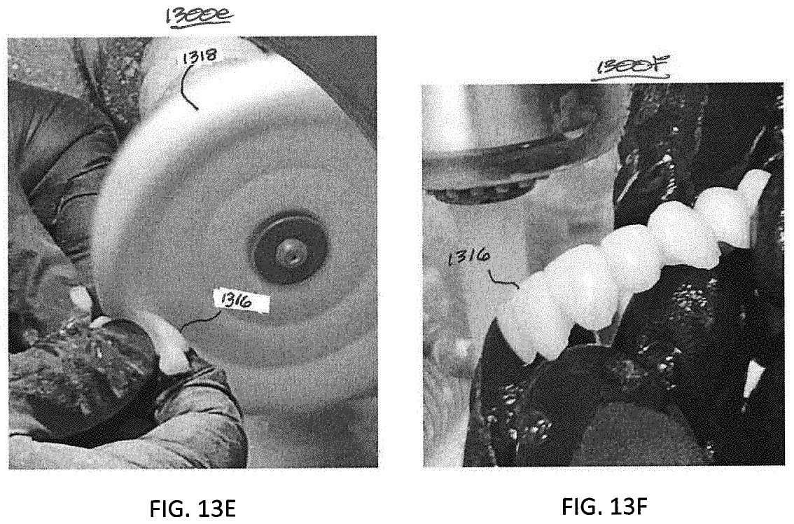

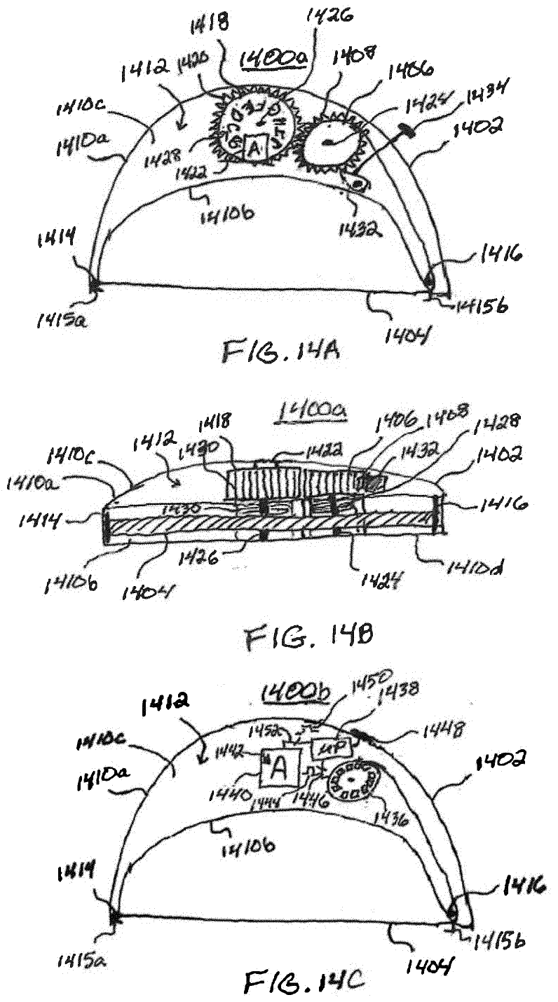

While the additional teeth are on a side of the patient-specific stent on which the patient does not have another natural tooth, because the temporary dental coverings are only meant to last a few weeks or a couple of months before the permanent dental coverings are to be mounted to the prepped natural teeth and/or anchors or posts, it is possible that the temporary dental coverings at the end not protected by another natural tooth may break off, which means that the patient is to be careful if he or she wishes to maintain those temporary dental coverings. However, the patient will basically have a full smile because all of the front six (or more) teeth will be visible when he or she smiles until a time that those unattached manufactured model teeth 1206 detach from the remainder of the temporary dental coverings (see FIG. 13A-13F and 14B, for example).

As an alternative process for preparing the temporary dental coverings, rather than modifying the stone-based model 200 of FIG. 2, the baseline stents available in the bins of FIG. 5 may be filled with flowable material and be applied directly to teeth of a patient. The result of applying the baseline stent to existing teeth is may be considered a direct model that forms the “model” teeth (i.e., teeth in the shape of another person) that fits the patient's actual teeth. By performing a direct molding process using a baseline stent that is sized-selected to fit the patient based on the measurement of the span between left and right side teeth (e.g., canine to canine), the process of augmenting the stone-based model to produce an augmented stone-based model (see FIGS. 7C) may be eliminated since using the stent to produce a model is a direct method for producing a direct augmented model that can be used thereafter. The direct augmented model may be formed of acrylic or other hardening material may be used due to the volume of material that may be needed, especially if a tooth is missing or a large gap between the actual teeth and the baseline stent exists. There may be situations where creation of a missing tooth using the baseline stent is not preferred or desired and the direct augmented model may be altered thereafter to include a missing tooth, as previously described with regard to FIGS. 8A-8D.

Because a baseline model is directly applied to the patient's actual teeth, if the patient is missing a tooth, the baseline stent may automatically create a missing tooth, as opposed to having to add the missing tooth later on, as was described in FIGS. 8A-8D for the augmented stone-based mold. It should be understood that augmentations may be made to the direct augmented model to remove various artifacts that may cause discomfort to the patient or improve shape in any other way. The augmentations may be performed by hand, for example, and may include removing, adding, or modifying the hardened material of the direct augmented model. As with the augmented stone-based model, the direct augmented model may be thinned to form a thinned direct augmented model, as was performed in FIG. 9 or otherwise, to make creation of the patient-specific stent, such as performed in FIG. 11. In other words, the direct augmented model (as may be modified after the initial direct augmented model is formed) may be used in the same or similar manner as was the thinned augmented model 802″ in forming a patient-specific stent, such as the patient-specific stent 1102. Using this direct model technique with a baseline stent that is appropriately sized for the patient, the process may be simplified with the number of steps and missing teeth may be more easily be created.

With regard to FIGS. 13A-13F, images of steps 1300a-1300f (collectively 1300) of an illustrative sub-process for processing an impression formed of a hardening material of prepped teeth of a patient by using a patient-specific stent produced by the thinned augmented model 802″ of FIG. 9 is shown. The hardening material may be acrylic or any other hardening material that may be used to form temporary dental coverings. FIG. 13A shows a raw impression 1302 after the hardening material is removed from the patient-specific stent. In FIG. 13B, a rotary drill 1304 with an extended drill shaft 1306 may be used to remove excess material, remove material that is not needed, and perform initial shaping or sculpting of the raw impression 1302 in producing the temporary dental covering. The raw impression 1302 shown includes indentation impressions 1308a-1308n of the prepped natural teeth (e.g., stubbed shaved teeth) in the hardening material, which is how the temporary dental covering will be secured within the patient's mouth using an adhesive or other hardening agent. As also shown, in region 1310 where natural teeth do not exist on the end where the additional manufactured model teeth 1206 (FIG. 12C) were added in the sub-process of FIGS. 12A-12C, no indentation impressions of prepped natural teeth are shown in the impression. FIGS. 13C and 13D show how the rotary drill 1304 with a circular tip 1312 may be used to form cleavages or borders 1314a-1314m between impression teeth 1316a-1316n (dental coverings 1316) that define a temporary dental coverings 1316 between a first sculpting time and a second sculpting time. As sculpting is performed, the raw impression 1302 that is being formed into the temporary dental coverings 1316 takes the shape and appearance of natural teeth.

With regard to FIG. 13E, step 1300e includes a buffing process that may be used to smoothen and shine the temporary dental coverings 1316. The buffing process using a rotating buffer 1318 may include coating the temporary dental coverings 1316 with a very fine abrasive and then using a rotating buffer to smoothen and shine the temporary dental coverings 1316. The fine abrasive may include, for example, a pumice or other fine abrasive. FIG. 13F shows that the buffing material is washed off, which reveals buffed, shiny, natural-looking temporary dental coverings. Thereafter, the temporary dental coverings 1316 may be fitted into the patient's mouth and any further alterations to the temporary dental coverings 1316 may be made to improve comfort and/or alignment of the temporary dental coverings 1316 in the patient's mouth. Once finalized, the patient's prepped natural teeth, which may now be shaped as circular or other shaped stumps, may be dried and an adhesive may be used to adhere the temporary dental coverings 1316 to the prepped natural teeth. Because the temporary dental coverings 1316 appear so natural, the patient is generally overwhelmed with the sight of his or her smile that previously included crooked and/or missing natural teeth.

With regard to FIGS. 14A and 14B, illustrations of an illustrative measurement tool 1400a for use in measuring a distance of a total span between a tooth on a left side of a patient's mouth and a corresponding tooth on a right side of the patient's mouth are shown. The measurement tool 1400a is a fully mechanical device in that the measurement is made and presented using only mechanical components. The measurement tool 1400a may include a housing 1402 and may use a flexible material 1404, such as a tape that is composed of Mylar or other material that has a long life and little or no stretch over time. In addition, the flexible material should have good wear performance (e.g., limited ability to snag or catch on a stone-based model, limited ability to kink or otherwise distort, etc.). The flexible material 1404 may be engaged with a wheel 1406 that either directly or indirectly is connected to teeth 1408 that operate as a gear.

The housing 1402 may be defined by a front wall 1410a, rear wall 1410b, top wall 1410c, and bottom wall 1410d. Alternative shapes may be utilized. As shown, the rear wall 1410b is curved in the shape of an arc, which enables the flexible material 1404 to be pressed towards the rear wall 1410b when the measurement tool 1400a is in operation. The walls measurement tool 1400a may define an enclosure 1412 within which measurement components may be positioned. An anchor post 1414 to which the flexible material 1404 connects and another post 1416, either stationary or revolving, around which the flexible material 1404 is routed to the wheel 1406. By either directly or indirectly connecting to the wheel 1406 and the post 1414, when the flexible material 1404 is moved, the wheel 1406 rotates. Measurement features 1415a and 1415b may be utilized to place on rear edges (space between teeth) of respective right and left corresponding teeth (e.g., canine teeth).

Another wheel 1418 may also be directly or indirectly connected to teeth 1420 that form a corresponding gear component. In an embodiment, the teeth 1408 and 1420 of each of the respective wheels 1406 and 1418 are engaged with one another such that when the wheel 1406 rotates, the wheel 1420 is caused to rotate in an opposite direction. It should be understood that alternative gear configurations may be utilized, including having multiple gears that are set up with specific gear ratios (e.g., 3:1, 5:1, 10:1, 100:1, 1:5, or otherwise) to cause the gear 1418 to have a smaller or larger rotation when the wheel 1406 is rotated. As further shown, a window 1422 may be positioned above a top surface of the wheel 1418. The wheel 1406 may rotate around a center post 1424 and the wheel 1420 may rotate around a center post 1426. Marked on the top surface of the wheel 1418 are identifiers, in this case letters A-J, that are positioned within the window 1422 when the flexible material 1404 is moved a corresponding distance, as further described with regard to FIG. 14C. It should be understood that alternative identifiers may be utilized.

In one embodiment, the flexible material 1404 may define repeating openings (e.g., one or two rows or tracks longitudinally extending along the flexible material 1404 and protrusions may be positioned on the post 1416, if rotatable, and/or wheel 1406 or feature connected to the wheel 1406 on which the flexible material 1404 may engage so as to be maintained in a proper position on the measurement tool 1400a). It should be understood that alternative configurations may be utilized to perform the same or similar measuring function. In an alternative embodiment, rather than using a wheel 1406, a lever arm that rotates the wheel 1418 or otherwise causes identifiers positioned on a moveable feature to be positioned in the window 1422 may be utilized.

With regard to FIG. 14B, the wheels 1406 and 1418 are shown to be engaged with springs 1428 and 1430, which are utilized to maintain the flexible material 1404 in a taught state so that the flexible material 1404 does not develop slack and pull away from the measurement tool 1400a. The spring 1428, of course, may cause the wheel 1406 to rotate in a counterclockwise direction while the use of the measurement tool 1400a causes the wheel 1406 to rotate in a clockwise direction. Because a dental professional using the measurement tool 1400a may use the device on a model (e.g., model 200) or patient directly and the medical professional may have the measurement tool 1400a oriented in a direction that he or she may have a difficult view of the identifiers in the window, a brake mechanism 1432, such as a cam with a spring (not shown) that biases the cam towards the gear teeth 1408, thereby preventing the wheel 1406 from rotating backwards. By preventing the wheel 1406 from rotating backwards, a maximum distance on the wheel 1418 may be maintained when in use. A brake release 1434 accessible via the housing 1402 may enable the wheel 1406 to rotate back to a ready-for-use state. It should be understood that the brake 1432 may alternatively be positioned to engage with the teeth 1420 of the wheel 1418.

With regard to FIG. 14C, an illustration of an alternative embodiment of the measurement tool 1400b that utilizes digital measuring features is shown. Rather than using wheels with gears, this measurement tool 1400b utilizes an optical encoder 1436 to sense distance of motion of the flexible material 1404 in communication with a processor 1438 for counting a number of pulses representative of rotation of the optical encoder 1436. The processor 1438 may be a microprocessor, but may alternatively be simple counter formed using non-processor electronics. An electronic display 1440 may be in communication with the processor 1434, and be configured to display an identifier 1442, such as alphanumeric values (e.g., “A”-“J”). Data signals 1444, such as pulses, may be communicated via an electrical conductor 1446 to the processor, and the processor 1438 may communicate digital signals to the electronic display 1440 via a data bus 1444. In an embodiment, the processor 1438 may be configured to store a maximum value when used after being reset.

A maximum reset button 1448 may generate a reset signal 1450 communicated via an electrical conductor 1452 to enable a user to reset the measurement value (i.e., identifier 1442), and thereafter when used, a maximum value (e.g., identifier) due to motion of the flexible material 1404 may be maintained and displayed on the electronic display 1440. The ability to maintain a maximum value makes the measurement tool 1400b (and tool 1400a) easier to use.

In an embodiment, the one or both posts 1414 and 1416 or portions of the housing 1402 to which the posts are mounted may be extendable to provide additional distance between the flexible material 1404 at position A (i.e., when extending horizontally across without curvature) and the rear wall 1410b. In an embodiment, the post 1414 may remain fixed, and post 1416 may be altered forward during measurements so that the measurement feature 1415b may be aligned with a rear edge of a tooth (i.e., an edge of a tooth toward a next tooth farther away from the front teeth). If an adjustment is possible for the post(s) 1414 and/or 1416, then the measurement tool(s) 1400a and/or 1400b may be configured to provide for a recalibration to reset the identifier back to A because repositioning of the posts 1414 and 1416 forward or backward relative to the rear wall 1410b will cause movement of the wheel 1406 (FIG. 14A). It should be understood that having the ability to move either or both of the posts 1414 and 1416 also allows for aligning the posts with a tooth (e.g., left canine) of the left side of a patient's mouth and a corresponding tooth (e.g., right canine) on the rights side of a patient's mouth.

With regard to FIG. 15A and 15B, illustrations of the measurement tool 1400a of FIG. 14A being used to measure the stone-based model 200 made by taking an impression of natural teeth of a patient are shown. In FIG. 15A, the stone-based model 200 begins to be pushed into a measurement position by pressing front teeth 402c and 402d of the model 200 into the flexible material 1404. Because the flexible material is held to the post 1414, the flexible material 1404 begins to slide past the post 1416 to cause the wheel 1406 to spin. As the wheel 1406 spins, the teeth 1408 being intermeshed with teeth 1420 causes the wheel 1418 to spin in the opposite direction. As shown, as the wheel 1418 begins to spin, the identifiers 1428 rotate with the wheel and the identifier in the window 1422 begins to move from A to B. As shown in FIG. 15B, as the model 200 is fully moved into position such that a full span extending from outside edges of left and right canine teeth 402a and 402b, the identifiers 1428 rotate and an identifier E is displayed in the window 1422. The dental professional is thus informed by the measurement by the measurement tool 1400a that baseline stent E is to be selected from a bin, for example, for use in enhancing the stone-based model, as described with regard to the sub-process shown in FIGS. 7A-7C.

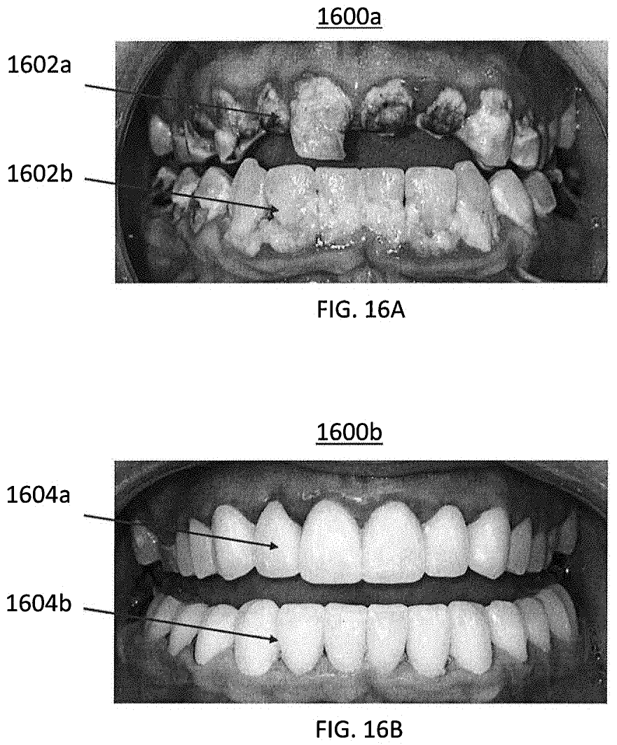

FIGS. 16A and 16B, images of an untreated smile 1600a and a treated smile 1600b of a patient are shown. The untreated smile 1600a includes upper and lower natural teeth 1602a and 1602b (collectively 1602), while the treated smile 1600b includes temporary upper and lower dental coverings 1604a and 1604b (collectively 1604). The processes described with regard to FIGS. 1-13F are performed to treat the untreated smile 1600a by creating the temporary dental coverings 1604, prepping the natural teeth 1602, and securing the temporary dental coverings 1604 to the prepped natural teeth 1602.

One embodiment of a dental kit may include multiple baseline stents having sizes ranging from a minimum size to a maximum size. The baseline stents may have respective shapes of teeth and gums of one or more persons for use in augmenting a stone-based model produced from natural teeth of a patient who is not any of the one or more persons.

The sizes of at least three of the baseline stents may have approximately equal spacings of sizes between adjacent sized baseline stents. The baseline stents of different sizes may be assigned different identifiers. A set of bins in which the baseline stents are arranged according to size may be included as part of the kit. The baseline stents may include perforations between teeth portions.

A measurement tool may be configured to enable a medical professional to measure a total span between a first tooth on a left side of a patient's mouth and a second tooth on a right side of a patient's mouth. The measurement tool is configured to press against a patient's natural teeth or a front of a stone-based model formed from an impression of a patient. The measurement tool may include a mechanical or electrical display configured to display an indicator with an identifier from amongst a plurality of identifiers associated with respective sized baseline stents.

One embodiment of a dental kit may include a measurement tool configured to measure a physical parameter between a tooth on a left side of a mouth and a tooth on a right side of a mouth, and multiple baseline stents sized within a lower and an upper range of the physical parameter. The baseline stents may have respective shapes of teeth and gums of one or more persons for use in augmenting a stone-based model produced from natural teeth of a patient who is not any of the one or more persons.

The measurement tool may be configured to measure a total span across a front side of teeth between a first location of first tooth on a left side of a patient's mouth and a second location of a second tooth on a right side of a patient's mouth, where the first and second locations may be reflective locations of the first and second teeth. The measurement tool may be configured to press against the front side of patient's natural teeth or the front side of teeth of the patient formed by a stone-based model formed from an impression of the natural teeth of the patient. The measurement tool may include a mechanical or electrical display configured to display an indicator with an identifier from amongst a plurality of identifiers associated with respective sized baseline stents.

The baseline stents may be organized in bins according to size. The bins may be arranged in a row. One or more second rows may be positioned above the row of bins, wherein one or more segments defining one or more individual teeth of the same respective side of baseline stents stored in the row of bins are stored in vertical alignment of the respective same size baseline stents in the one or more second rows.

One embodiment of a measurement tool may include a housing, a flexible tape configured to measure a physical parameter spanning between a tooth on a left side of a mouth and a tooth on a right side of a mouth, and an indicator mechanism, driven by the flexible tape, to display an indicator of a size of a stent from a plurality of different sized baseline stents to be selected based on the indicator.

The measurement tool may be configured to enable the flexible tape to be pressed against the front side of patient's natural teeth or the front side of teeth of the patient formed by a stone-based model from an impression of the natural teeth of the patient. The indicator mechanism may include a mechanical or electrical display configured to display the indicator with an identifier from amongst a plurality of identifiers associated with respective sized baseline stents.

The housing may include a top portion and bottom portion, and define a front end and a back end. The front end may have a concave shape towards the back end. The indicator mechanism may include a rotational member positioned within the housing, the flexible tape is positioned at a front location of the housing. The flexible tape may have one end fixedly positioned relative to one side of the housing and the other end attached to the rotational member.

A brake mechanism may be configured to maintain the indicator mechanism at a maximum reading during a measurement by the measurement tool. A method of measuring a span across teeth may include displacing a flexible tape in response to the flexible tape of a measurement tool being pressed against a front surface of teeth of a patient. An indicator mechanism may be altered in response to the flexible table being displaced to cause an indicator indicative of a distance of the span between a first tooth on a left side of the patient's mouth and a second tooth on a right side of the patient's mouth to be displayed. The indicator indicative of a size of a baseline stent from a multiple different sized baseline stents to be selected based on the indicator may be displayed.

The flexible tape being displaced may include displacing the flexible tape in response to the flexible tape being pressed against the front surface of teeth of the patient as formed in a stone-based model. Altering the indicator mechanism may include rotating a wheel that causes the indicator mechanism to rotate.

One measurement tool may include a housing, a flexible tape configured to measure a physical parameter spanning between a tooth on a left side of a mouth and a tooth on a right side of a mouth, and an indicator mechanism, driven by the flexible tape, to display an indicator of a size of a stent from a plurality of different sized baseline stents to be selected based on the indicator.

The housing may be configured to enable the flexible tape to be pressed against the front side of patient's natural teeth or the front side of teeth of the patient formed by a stone-based model from an impression of the natural teeth of the patient. The indicator mechanism may include a mechanical or electrical display configured to display the indicator with an identifier from amongst a plurality of identifiers associated with respective sized baseline stents.

The housing may include a top portion and bottom portion, and may further define a front end and a back end. The front end of the housing may have a concave shape towards the back end. The indicator mechanism may include a rotational member positioned within the housing, and the flexible tape may be positioned at a front location of the housing. The flexible tape may have one end fixedly positioned relative to one side of the housing and the other end attached to the rotational member. The measurement tool may further include a brake mechanism configured to maintain the indicator mechanism at a maximum reading during a measurement by the measurement tool.

One embodiment of a method of measuring a span across teeth may include displacing a flexible tape in response to the flexible tape of a measurement tool being pressed against a front surface of teeth of a patient. An indicator mechanism may be altered in response to the flexible table being displaced so as to cause an indicator indicative of a distance of the span between a first tooth on a left side of the patient's mouth and a second tooth on a right side of the patient's mouth to be displayed. The indicator indicative of a size of a baseline stent from a plurality of different sized baseline stents to be selected based on the indicator may be displayed.

Displacing the flexible tape may include displacing the flexible tape in response to the flexible tape being pressed against the front surface of teeth of the patient as formed in a stone-based model. Altering the indicator mechanism may include rotating a wheel that causes the indicator mechanism to rotate.

Another process of forming a set of at least one temporary dental covering may include selecting, based on the measured distance, a baseline stent from amongst a plurality of sizes of baseline stents formed from a mold of natural teeth and gums of a different person. Hardening material to be hardened may be disposed into the selected baseline stent. The selected baseline stent with the hardening material may be placed onto actual teeth of the patient until the hardening material hardens, thereby forming a direct augmented mold of the patient's natural teeth and gums and inclusive of molded teeth in the shape of the different person's natural teeth and gums. An augmented stent of the patient's existing natural teeth using the augmented mold may be formed. Hardening material may be disposed into the augmented stent. At least one natural tooth of the patient may be prepared by reducing size and shape thereof to form at least one anchor tooth to be used for the set of at least one temporary dental covering. An augmented impression mold may be formed by placing the augmented stent with the hardening material onto the patient's prepared teeth and gums to form an initial set of temporary teeth. The initial set of temporary teeth may be removed from the augmented mold. The initial set of temporary teeth may be sculpted to make the set of temporary teeth more realistic to form a sculpted set of temporary dental coverings. The sculpted temporary teeth may be secured to the prepared natural teeth and gums of the patient.

The process may further include measuring a distance between (i) a first natural tooth on a left side of the patient's mouth and (ii) a second natural tooth on the right side of the patient's mouth. Measuring a distance may include measuring a distance that spans the front of the natural teeth from mirror image locations of the patient's natural left and right side teeth.

A stent size identifier may be generated based on the measured distance between the first tooth on the left side of the patient's mouth and the second tooth on the right side of the patient's mouth. Generating a stent size identifier may include generating a letter. At least one anchor may be installed in the patient's gums for use in anchoring a permanent dental covering, where securing the sculpted temporary teeth to the prepared teeth and gums may include securing the sculpted temporary teeth to the prepared teeth and gums and overlaying a sculpted temporary dental covering over the at least one anchor.

As used herein, the singular forms “a,” “an,” and “the” are intended to include the plural forms as well, unless the context clearly indicates otherwise. Also, the plural form of “teeth” may be construed as meaning one or more tooth.

As used herein, “or” includes any and all combinations of one or more of the associated listed items in both, the conjunctive and disjunctive senses. Any intended descriptions of the “exclusive-or” relationship will be specifically called out.

As used herein, the term “configured” refers to a structural arrangement such as size, shape, material composition, physical construction, logical construction (e.g., programming, operational parameter setting) or other operative arrangement of at least one structure and at least one apparatus facilitating the operation thereof in a defined way (e.g., to carry out a specific function or set of functions).

As used herein, the phrases “coupled to” or “coupled with” refer to structures operatively connected with each other, such as connected through a direct connection or through an indirect connection (e.g., via another structure or component).

The previous description is of various preferred embodiments for implementing the disclosure, and the scope of the invention should not necessarily be limited by this description. The scope of the present invention is instead defined by the claims.

1. A method of forming a set of at least one temporary dental covering, comprising:
capturing an impression of existing natural teeth and gums of a patient to be used to form a mold of the patient's gums and natural teeth;
measuring a distance between (i) a first natural tooth on a left side of the patient's mouth and (ii) a second natural tooth on the right side of the patient's mouth;
selecting, based on the measured distance, a baseline stent from amongst a plurality of sizes of baseline stents formed from a mold of natural teeth and gums of a different person;
disposing hardening material to be hardened into the selected baseline stent;
placing the selected baseline stent with the hardening material onto the mold of the patient until the hardening material hardens, thereby forming an augmented mold of the patient's natural teeth and gums and inclusive of altered and/or additional molded teeth in the shape of the different person's natural teeth and gums;
forming an augmented stent of the patient's existing natural teeth using the augmented mold;
disposing hardening material into the augmented stent;
preparing at least one natural tooth of the patient by reducing size and shape thereof to form at least one anchor tooth to be used for the set of at least one temporary dental covering;
forming an augmented impression mold by placing the augmented stent with the hardening material onto the patient's prepared teeth and gums to form an initial set of temporary teeth;
removing the initial set of temporary teeth from the augmented mold;
sculpting the initial set of temporary teeth to make the set of temporary teeth more realistic to form a sculpted set of temporary dental coverings; and
securing the sculpted temporary teeth to the prepared natural teeth and gums of the patient.

2. The method according to claim 1, wherein measuring includes:
placing a measuring tool onto the mold; and
determining the distance between the first and second natural teeth across a front side of the front teeth of the mold.

3. The method according to claim 1, further comprising generating a stent size identifier based on the measured distance between the first tooth on the left side of the patient's mouth and the second tooth on the right side of the patient's mouth.

4. The method according to claim 3, wherein selecting, based on the measured distance, a pre-fabricated baseline stent include selecting a stent having a common stent identifier to the generated stent size identifier.

5. The method according to claim 1, wherein measuring the distance includes measuring the distance between (i) the canine tooth on a left side of the patient's mouth and (ii) the canine tooth on the right side of the patient's mouth.

6. The method according to claim 1, wherein measuring the distance includes measuring the distance between (i) the lateral incisor on a left side of the patient's mouth and (ii) the lateral incisor on the right side of the patient's mouth.

7. The method according to claim 1, wherein measuring the distance includes applying a measuring tool to the mold of the patient's mouth.

8. The method according to claim 7, further comprising moving first and second features of the measuring tool.

9. The method according to claim 1, wherein measuring the distance includes applying a measuring tool to natural teeth of the patient.

10. The method according to claim 1, further comprising:
installing at least one anchor for use in anchoring a permanent dental covering; and
wherein securing the sculpted temporary teeth to the prepared teeth and gums includes securing the sculpted temporary teeth to the prepared teeth and gums and overlaying a sculpted temporary dental covering over the at least one anchor.

11-34. (canceled)

35. A method of forming a set of at least one temporary dental covering, comprising:
selecting, based on the measured distance, a baseline stent from amongst a plurality of sizes of baseline stents formed from a mold of natural teeth and gums of a different person;
disposing hardening material to be hardened into the selected baseline stent;
placing the selected baseline stent with the hardening material onto actual teeth of the patient until the hardening material hardens, thereby forming a direct augmented mold of the patient's natural teeth and gums and inclusive of molded teeth in the shape of the different person's natural teeth and gums;
forming an augmented stent of the patient's existing natural teeth using the augmented mold;
disposing hardening material into the augmented stent;
preparing at least one natural tooth of the patient by reducing size and shape thereof to form at least one anchor tooth to be used for the set of at least one temporary dental covering;
forming an augmented impression mold by placing the augmented stent with the hardening material onto the patient's prepared teeth and gums to form an initial set of temporary teeth;
removing the initial set of temporary teeth from the augmented mold;
sculpting the initial set of temporary teeth to make the set of temporary teeth more realistic to form a sculpted set of temporary dental coverings; and
securing the sculpted temporary teeth to the prepared natural teeth and gums of the patient.

36. The method according to claim 35, further comprising measuring a distance between (i) a first natural tooth on a left side of the patient's mouth and (ii) a second natural tooth on the right side of the patient's mouth.

37. The method according to claim 36, wherein measuring a distance includes measuring a distance that spans the front of the natural teeth from mirror image locations of the patient's natural left and right side teeth.

38. The method according to claim 36, further comprising generating a stent size identifier based on the measured distance between the first tooth on the left side of the patient's mouth and the second tooth on the right side of the patient's mouth.

39. The method according to claim 38, wherein generating a stent size identifier includes generating a letter.

40. The method according to claim 35, further comprising:
installing at least one anchor in the patient's gums for use in anchoring a permanent dental covering; and
wherein securing the sculpted temporary teeth to the prepared teeth and gums includes securing the sculpted temporary teeth to the prepared teeth and gums and overlaying a sculpted temporary dental covering over the at least one anchor.
